(19) United States
(12) Patent Application Publication
(10) Pub. No.: US 2008/0232431 A1
(43) Pub. Date: Sep. 25, 2008

(54) Electronic key system and method

(75) Inventors: Kenichiro Sanji, Okazaki-city (JP); Akira Takaoka, Okazaki-city (JP); Hiromichi Naito, Okazaki-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-ity (JP); NIPPON SOKEN, INC., Nishio-city (JP)

(21) Appl. No.: 12/073,851

(22) Filed: Mar. 11, 2008

(30) Foreign Application Priority Data
Mar. 19, 2007 (JP) 2007-070962

(51) Int. Cl. H04B 1/00

(52) U.S. Cl. 375/130; 375/E01.001

(57) ABSTRACT

An in-vehicle LF transmitter transmits a synchronization signal to an in-vehicle RF receiver and transmits LF data (response request) including a synchronization signal to a portable device. The portable device performs RF data output and DSSS process and transmits RF data (response) subjected to spread process. The in-vehicle RF receiver receives the RF data and performs despread process. Both of the spread process of the portable device and the despread process of the in-vehicle RF receiver are performed by the use of a spread code the period of which is adjusted based on the synchronization signal transmitted from the in-vehicle LF transmitter.

### CROSS REFERENCE TO RELATED APPLICATION

This application is based on and incorporates herein by reference Japanese Patent Application No. 2007-070962 filed on Mar. 19, 2007.

### FIELD OF THE INVENTION

The present invention relates to an electronic key system and method.

### BACKGROUND OF THE INVENTION

In a conventional electronic key system for vehicles, an electronic key system is constructed with a in-vehicle device mounted on a vehicle and a portable device held by a user of the vehicle. The electronic key system is constructed in a mechanism such that when verification of a user (portable device) by radio communication is made between the in-vehicle device and the portable device, even if an operation by a mechanical key is not performed, control such as locking/unlocking doors and starting an engine can be performed.

In the electronic key system, an ASK-FSK communication mode is often used for RF radio communication from the portable device to the in-vehicle device. This is because the ASK-FSK communication mode can simplify the scale of a circuit and hence can reduce the size of the portable device and the cost of the entire system.

However, various extraneous noises such as wide band noises covering an RF frequency band of the system and burst narrow band noises exit in actual vehicle environments, so that a system employing the ASK-FSK communication mode does not work well in some cases.

It is known as one of countermeasures against the extraneous noises like this to conduct communication by a communication system highly resistant to noises such as a spread spectrum method. Such systems are disclosed in, for example, U.S. Pat. No. 5,479,442 (JP-6-85782A), JP 10-22872A and JP 2000-224072A.

In the case where communications are conducted in the spread spectrum method, when despread is performed on a receiving side, a received signal cannot be demodulated unless the received signal is synchronized with a spread code. For this reason, the received signal is usually synchronized with the spread code by the use of a sliding correlator or a matched filter.

However, it takes considerable time by this technology until synchronization is achieved, which results in that the responsivity of the electronic key system tends to be decreased. In particular, in a system in which the transmission and reception are conducted again when transmission and reception cannot be correctly conducted, the time required to achieve synchronization is accumulated every time the transmission and reception are conducted. Thus, in this system, a decrease in responsivity as described above becomes more noticeable.

### SUMMARY OF THE INVENTION

It is therefore and object of the present invention to provide an electronic key system and method capable of improving resistance to noises by conducting communication by the use of a spread spectrum method and improving responsivity by shortening time required to achieve synchronization at the time of conducting despread.

According to one aspect of the present invention, an electronic key system and method are provided for a control object such as a vehicle. The system comprises a portable device carried by a user and an in-vehicle device mounted on a vehicle for conducting radio communication with the portable device to make verification of the portable device. The in-vehicle device transmits a synchronization signal when transmitting a radio signal to the portable device. The portable device transmits a radio signal in a spread spectrum method when transmitting the radio signal to the in-vehicle device. The portable device adjusts a period of a spread code used therein based on the synchronization signal to thereby synchronize the period of a spread code with a period of a spread code used in the in-vehicle device.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an electronic key system according to an embodiment of the present invention;

FIG. 2 is a flow chart of a first part of a process performed when a smart key entry function is used;

FIG. 3 is a flow chart of a second part of the process performed following the first part shown in FIG. 2;

FIG. 4 is a flow chart of a first part of a process performed when a remote keyless entry function is used; and

FIG. 5 is a flow chart of a second part of the process performed following the first part shown in FIG. 4.

### DETAILED DESCRIPTION OF THE PREFERRED EMBODIMENTS

An electronic key system has a smart entry function, which is for performing control such as unlocking doors when a specified portable device held by an authorized user of a control object such as a vehicle comes in a radio communication area in the vicinity of the control object. The system also has a remote keyless entry function, which is for performing control such as locking/unlocking doors according to a button operation using the portable device.

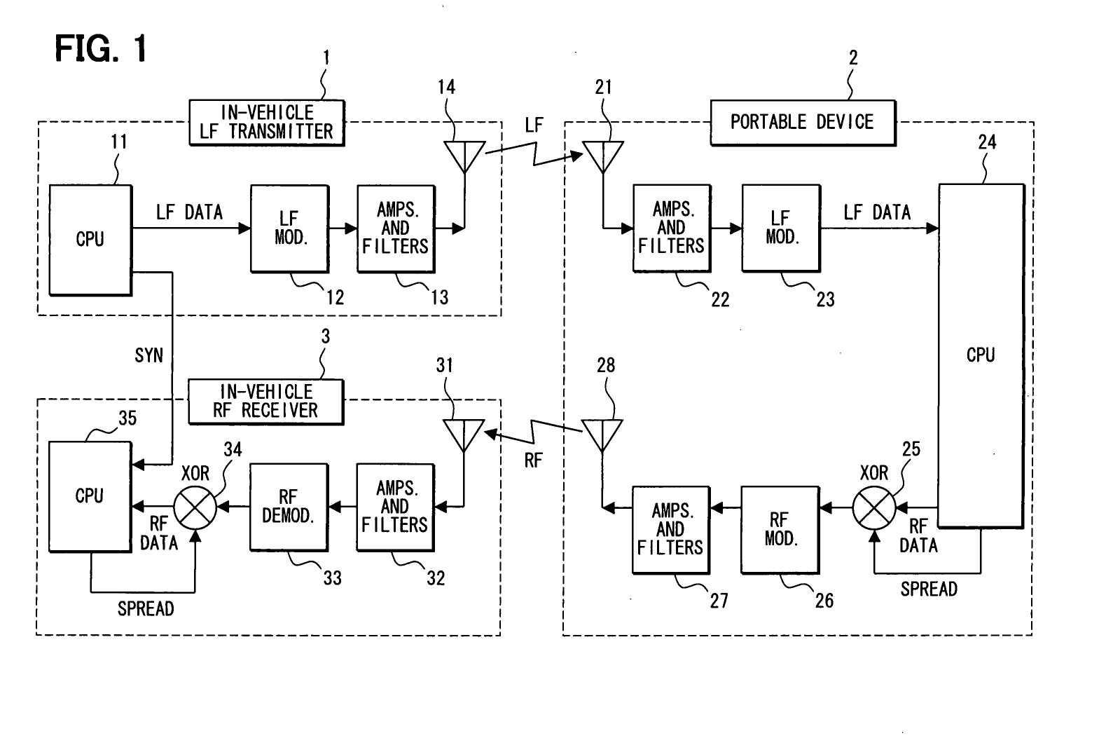

The electronic key system is applied to a vehicle in this embodiment. As shown in FIG. 1, the electronic key system has an in-vehicle LF transmitter 1, a portable device 2 and an in-vehicle RF receiver 3. The portable device 2 includes a LF-receiver/RF-transmitter as known well.

Of these devices, radio signals in an LF (low frequency) band are transmitted to the portable device 2 from the in-vehicle LF transmitter 1. Further, radio signals in an RF (radio frequency) band are transmitted in a spread spectrum method to the in-vehicle RF receiver 3 from the portable device 2. Here, the in-vehicle LF transmitter 1 and the in-vehicle RF receiver 3 are provided in as an in-vehicle device.

The in-vehicle LF transmitter 1 has a CPU 11, an LF modulator 12, amplifiers and filters 13, and an LF transmitting antenna 14. The CPU 11 transmits LF data including a synchronization signal. This LF data is modulated by the LF modulator 12, passed through the amplifiers and filters 13 and transmitted to the LF transmitting antenna 14. Further, CPU 11 is constructed so as to transmit the synchronization signal also to the in-vehicle RF receiver 3.

The portable device 2 has an LF receiving antenna 21, amplifiers and filters 22, an LF demodulator 23, a CPU 24, an XOR (exclusive-OR) operation circuit 25, an RF modulator 26, amplifiers and filters 27, and an RF transmitting antenna 28. An LF radio signal transmitted from the in-vehicle LF transmitter 1 is received by the LF receiving antenna 21, passed through the amplifiers and filters 22 and demodulated by the LF demodulator 23. As a result, LF data including a synchronization signal is transmitted to the CPU 24.

When the LF data including a synchronization signal is inputted to the CPU 24, the CPU 24 outputs RF data and a spread code in synchronization as instructed by the synchronization signal. The RF data and the spread code outputted from the CPU 24 are inputted to the XOR operation circuit 25. The output from the XOR operation circuit 25 is modulated by the RF modulator 26, passed through the amplifiers and filters 27 and transmitted to the RF transmitting antenna 28.

The in-vehicle RF receiver 3 includes an RF receiving antenna 31, amplifiers and filters 32, an RF demodulator 33, an XOR operation circuit 34, and a CPU 35. An RF radio signal transmitted from the portable device 2 is received by the RF receiving antenna 31, passed through the amplifiers and filters 32, demodulated by the RF demodulator 33 and inputted to the XOR operation circuit 34. Further, the CPU 34 outputs a spread code, and the spread code is inputted to the XOR operation circuit 34. The RF data outputted from the XOR operation circuit 25 is transmitted to the CPU 35.

Here, when a synchronization signal is transmitted from the in-vehicle LF transmitter 1 to the in-vehicle RF receiver 3, the CPU 35 outputs a spread code in synchronization as instructed by the synchronization signal, and the spread code is inputted to the XOR operation circuit 34.

Thus, in this case, both of the portable device 2 and the in-vehicle RF receiver 3 use the same spread code at the same period based on the synchronization signal from the in-vehicle LF transmitter 1. Hence, in this case, synchronization can be immediately achieved even without using a sliding correlator or a matched filter. Therefore, the RF data outputted from the XOR operation circuit 25 is normally despread.

On the other hand, in some cases, the synchronization signal may not transmitted to the in-vehicle RF receiver 3 from the in-vehicle LF transmitter 1. This is the case where the portable device 2 transmits a radio signal on its own, for example, the case where the remote keyless entry function is used, in which the LF transmitter 1 does not operate to perform the smart entry function.

In this case, the CPU 35 achieves synchronization in a mode corresponding to a sliding correlator. Specifically, the CPU 35 outputs a spread code as appropriate, and the spread code is inputted to the XOR operation circuit 34. In this case, there is also a possibility that synchronization will not be achieved immediately, but attempts to achieve synchronization are repeatedly made with the period of the spread code shifted and finally synchronization can be achieved.

If synchronization is achieved in any one of these modes, the RF data outputted from the XOR operation circuit 25 is normally despread. When the normally despread RF data is provided, the CPU 35 performs processes required to control various functions.

In this regard, the processes required to control various functions are not necessarily performed by the CPU, but it suffices for other control section provided with other CPU to perform the processes required to control various functions. In this case, it suffices for the CPU 35 to transmit the normally despread RF data to the other control section.

Further, it is also recommended that: the CPU 35 performs a part or all of the process of verification, for example, verifies whether a code in received RF data coincides with a code stored in its memory. Then, if a part or all of verification conditions are satisfied, the CPU 35 transmits the result that the verification conditions are satisfied to the other control section. Then, the other control section performs the processes required to control various functions.

In this regard, the process required to control various functions includes process relating to the control of locking doors, process relating to the control of starting an engine. These controls are well known in the electronic key system, so that the more specific descriptions of them will be omitted.

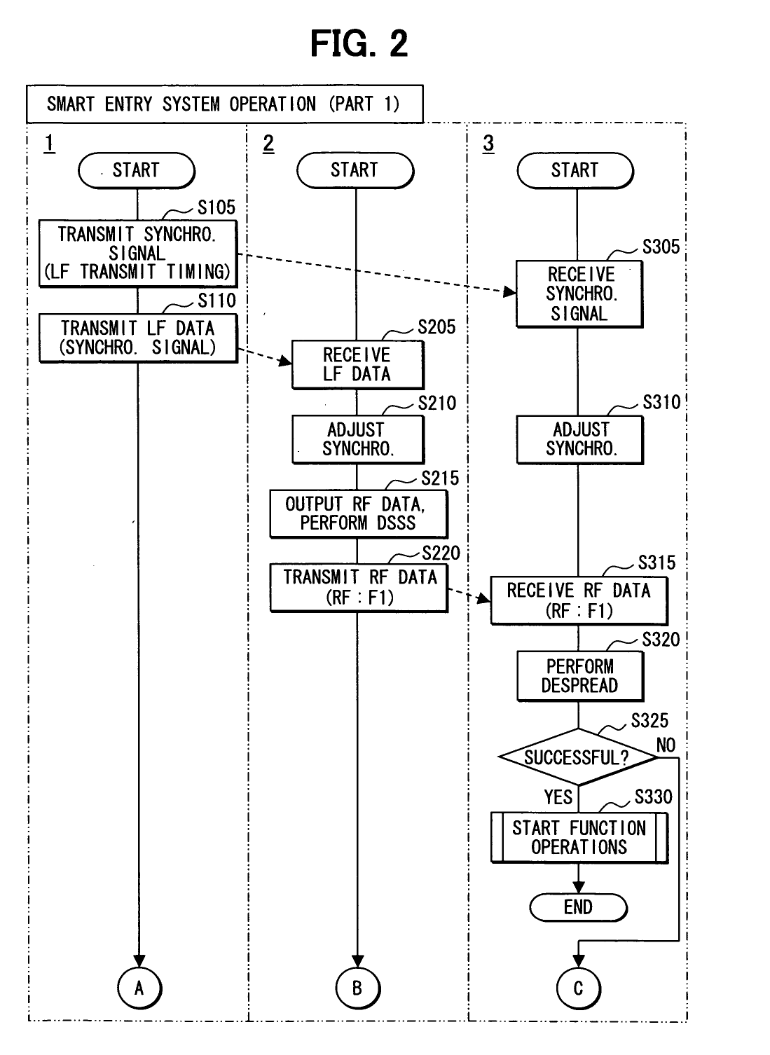

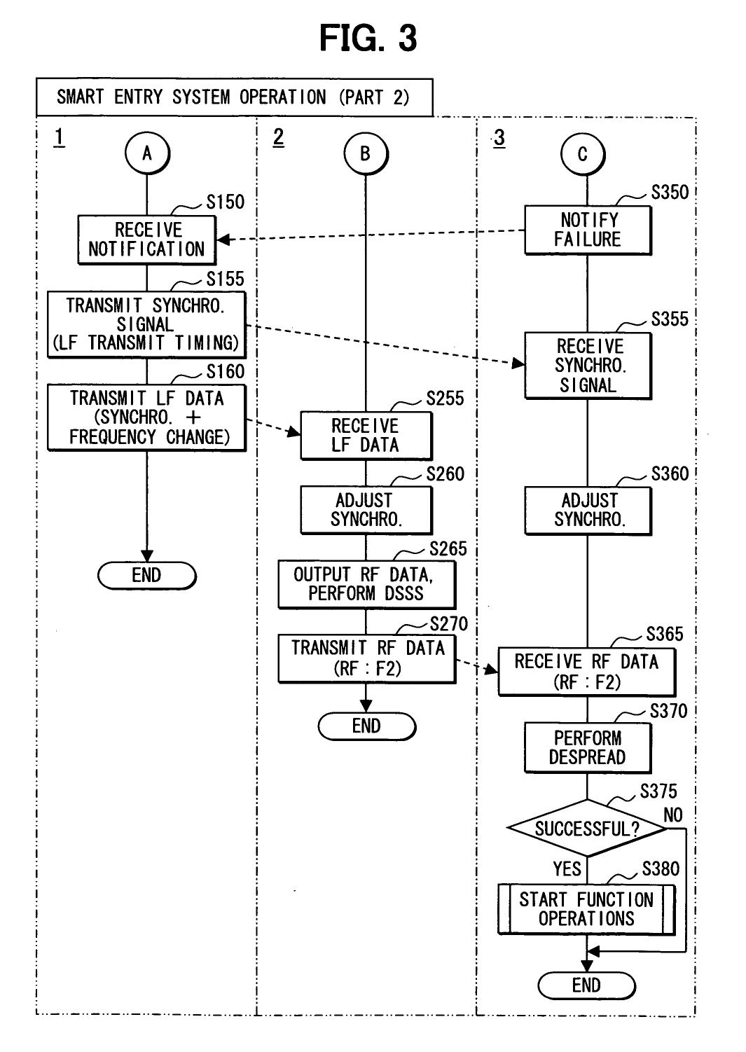

Next, processes performed respectively in the in-vehicle LF transmitter 1, the portable device 2, and the in-vehicle RF receiver 3 when a smart entry function is used will be described with reference to FIG. 2 and FIG. 3.

These processes are performed when the portable device 2 sends back a response on cue of the process performed first by the in-vehicle LF transmitter 1.

Specifically, first, the in-vehicle LF transmitter 1 transmits a synchronization signal to the in-vehicle RF receiver 3 (S105) and transmits LF data (request for response) including a synchronization signal to the portable device 2 (S110).

At this time, the in-vehicle RF receiver 3 receives the synchronization signal transmitted by the process of S105 (S305). Further, when the portable device 2 is present within a communication area near the vehicle, the portable device 2 receives the synchronization signal transmitted by the process of S110 (S205).

In this regard, in the flow chart shown in FIG. 2, for the sake of convenience, the synchronization signal is transmitted to the in-vehicle RF receiver 3 and then the synchronization signal is transmitted to the portable device 2. However, in the process to be described later, if synchronization can be achieved between the portable device 2 and the in-vehicle RF receiver 3, the order of transmission of the synchronization signal is not limited to a particular order.

Further, the synchronization signal transmitted to the portable device 2 and the synchronization signal transmitted to the in-vehicle RF receiver 3 are not required to have the same data structure if the synchronization signals are capable of achieving synchronization between the portable device 2 and the in-vehicle RF receiver 3.

The portable device 2 receiving the synchronization signal by the process of S205 adjusts synchronization based on the synchronization signal in the next step (S210). Specifically, the period of the spread code outputted to the XOR operation circuit 25 from the CPU 24 is adjusted so as to coincide with the period indicated by the synchronization signal.

Then, the portable device 2 performs outputting RF data and DSSS (direct sequence spread spectrum) process (S215) and transmits RF data (response) subjected to the spread process (S220). In the process of S215, the spread process is performed by the use of the spread code the period of which is adjusted by the process of S210.

Here, in the process of S220, a frequency F1 is used as the transmission frequency of the RF data. The use of this frequency F1 may be predetermined in the system or may be notified to the portable device 2 from the in-vehicle LF transmitter 1 when the in-vehicle LF transmitter 1 transmits the LF data in the process of S110 (or S205).

On the other hand, the in-vehicle RF receiver 3 receiving the synchronization signal by the process of S305 also adjusts synchronization based on the synchronization signal (S310). Specifically, the period of the spread code outputted to the XOR operation circuit 34 from the CPU 35 is adjusted so as to coincide with the period indicated by the synchronization signal.

Then, the in-vehicle RF receiver 3 receives the RF data (response) transmitted by the process of S220 (S315). Here, in the process of S315, the frequency F1 is used as a reception frequency.

When the in-vehicle RF receiver 3 receives the RF data by the process of S315, the in-vehicle RF receiver 3 performs despread process (S320). In this process of S320, the despread process is performed by the use of the despread code the period of which is adjusted by the process of S310.

For this reason, both of the spread process by the process of S215 and the despread process by the process of S320 are performed by the use of the spread code the period of which is adjusted based on the synchronization signal transmitted from the in-vehicle LF transmitter 1. Thus, in the process of S320, even if synchronization is not achieved in a mode using a sliding correlator or a matched filter, synchronization can be achieved immediately based on the synchronization signal.

After the in-vehicle RF receiver 3 performs the despread process, the in-vehicle RF receiver 3 checks whether the in-vehicle RF receiver 3 succeeds in the despread (S325). Here, when the despread is successful (S325: YES), the in-vehicle RF receiver 3 performs the processes required to start operations of various functions (S330).

Here, the process of S330 includes the process of verifying the portable device 2 and finally the process relating to the control of locking doors, the process relating to the control of starting the engine, and the like. However, as already described above, it suffices for the in-vehicle RF receiver 3 to notify the other control section of only information to the effect that the in-vehicle RF receiver 3 has succeeded in the despread and for the other control section having received the notification to perform the processes required to control various functions.

On the other hand, when the in-vehicle RF receiver 3 fails in the despread in the process of S330 (S330: NO), there is a possibility that extraneous noises (interference waves) or the like will cause the environment in which communication using the frequency F1 cannot be properly performed. Thus, in this case, as shown in FIG. 3, the in-vehicle RF receiver 3 notifies the in-vehicle LF transmitter 1 of information to the effect that the in-vehicle RF receiver 3 has failed in the despread (S350).

In this case, the in-vehicle LF transmitter 1 receives the notification (failure in despread process) from the in-vehicle RF receiver 3 (S150) and again transmits the synchronization signal to the in-vehicle RF receiver 3 (S155) and transmits LF data (request for response) including the synchronization signal and frequency change information to the portable device 2 (S160). The frequency change information transmitted by the process of S160 is for notifying the in-vehicle RF receiver 3 that a frequency F2 different from the previously used frequency F1 is to be used.

As a result of the performance of this process, the in-vehicle RF receiver 3 receives the synchronization signal transmitted by the process of S155 (S355). Further, when the portable device 2 is present within a communication area near the vehicle, the portable device 2 receives the synchronization signal and the frequency change information transmitted by the process of S160 (S255).

Subsequently, like the process of S210, the portable device 2 adjusts synchronization based on the synchronization signal (S260). Then, the portable device 2 performs RF data output and DSSS process (S265) and transmits RF data (response) subjected to the spread process (S270). In this process of S270, the frequency F2 is used as the transmission frequency of the RF data, whereby interference caused when the frequency F1 is used can be avoided.

On the other hand, like the process of S310, also the in-vehicle RF receiver 3 having received the synchronization signal by the process of S355 adjusts synchronization based on the synchronization signal. Then, the in-vehicle RF receiver 3 receives the RF data (response) transmitted by the process of S270 (S365). Here, in this process of S365, the frequency F2 is used as a reception frequency.

When the in-vehicle RF receiver 3 receives the RF data by the process of S365, the in-vehicle RF receiver 3 performs the despread process (370). Also in this case, both of the spread process by the process of S265 and the despread process by the process of S370 are performed by the use of the spread code the period of which is adjusted based on the synchronization signal transmitted from the in-vehicle LF transmitter 1. For this reason, in the process of S370, even if synchronization is not achieved in the mode using the sliding correlator or the matched filter, synchronization can be achieved immediately based on the synchronization signal.

When the in-vehicle RF receiver 3 performs the despread process described above, the in-vehicle RF receiver 3 checks whether the in-vehicle RF receiver 3 succeeds in despread (S375). Here, when the despread process is successful (S375: YES), like the process of S330, the in-vehicle RF receiver 3 performs the process for starting the operations of various functions (S380).

On the other hand, when the in-vehicle RF receiver 3 fails in the despread in the process of 380 (S380: NO), the in-vehicle RF receiver 3 finishes the process without performing more process. That is, when the portable device 2 tries to conduct the first RF transmission at the frequency F1 and fails in the first RF transmission, the portable device 2 tries to conduct the second RF transmission at the frequency F2. Then, when the portable device 2 fails in the second RF transmission, the in-vehicle RF receiver 3 abandons the reception of information from the portable device 2 at that timing.

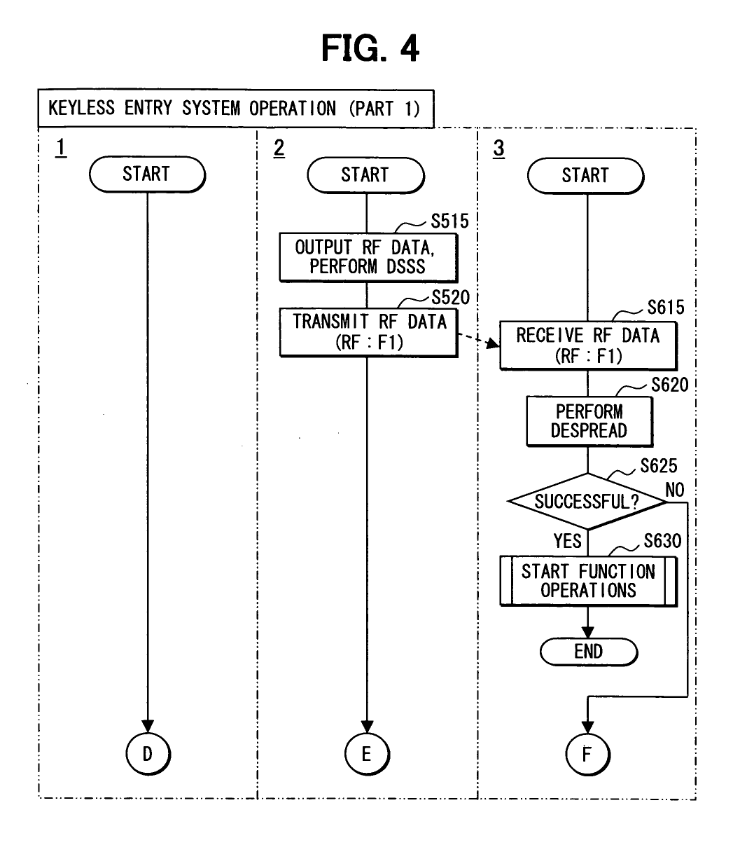

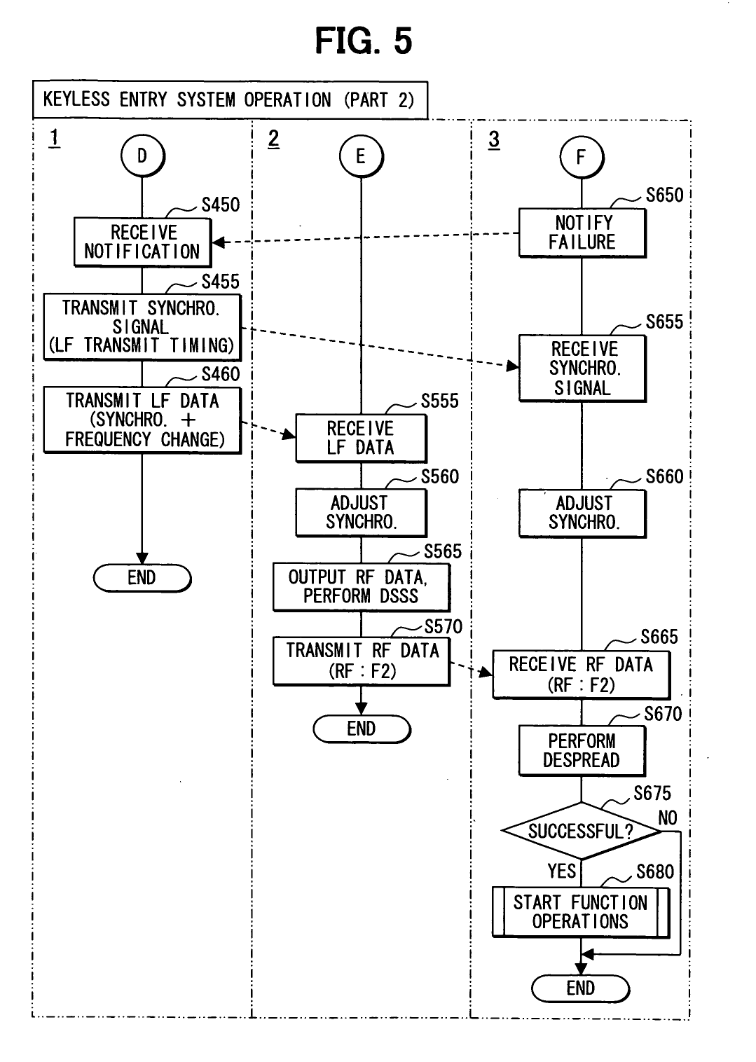

Next, processes performed respectively in the in-vehicle LF transmitter 1, the portable device 2, and the in-vehicle RF receiver 3 when a remote keyless entry function is used will be described with reference to FIG. 4 and FIG. 5.

These processes are performed when the in-vehicle LF transmitter 1 sends back a response on cue of the process performed first by the portable device 2. That is, the remote keyless entry function starts when the portable device 2 starts the process in response to the manual operation of the user on the portable device 2 as opposed to the start of the above smart entry function.

Specifically, first, when a user carrying the portable device 2 performs a specified operation on an operating part (not shown) of the portable device 2, the portable device 2 performs RF data output and DSSS process (S515) and transmits RF data (command) subjected to the spread process (S520). In the process of S515, the spread process is performed by the use of a spread code, but the spread code is used as it is asynchronous with the in-vehicle RF receiver 3, which is different from the process of S215 described above. Here, in the process of S520, the frequency F1 is used as the transmission frequency of the RF data.

The in-vehicle RF receiver 3 receives the RF data (command) transmitted by the process of S520 (S615). Here, in the process of S615, the frequency F1 is used as a reception frequency.

When the in-vehicle RF receiver 3 receives the RF data by the process of S615, the in-vehicle RF receiver 3 performs a revere spread process (S620). In this process of S620, synchronization is achieved in the mode using a sliding correlator. However, synchronization may be achieved in the mode using a matched filter.

Subsequently, the in-vehicle RF receiver 3 checks whether the in-vehicle RF receiver 3 succeeds in despread (S625). Here, when the in-vehicle RF receiver succeeds in the despread (S625: YES), the in-vehicle RF receiver performs processes required to start operations of various functions (S630). Here, the process of S630 includes the process of verifying the portable device 2 and finally the process relating to the control of locking doors, and the like. However, as already described above, it suffices for the in-vehicle RF receiver 3 to notify the other control section of only information to the effect that the in-vehicle RF receiver 3 has succeeded in the despread and for the other control sections having received the notification to perform the processes required to control various functions.

When the in-vehicle RF receiver 3 fails in the despread in the process of S625 (S625: NO), there is a possibility that extraneous noises (interference waves) or the like will cause the environment in which communication using the frequency F1 cannot be properly performed. Thus, in this case, as shown in FIG. 5, the in-vehicle RF receiver 3 notifies the in-vehicle LF transmitter 1 of information to the effect that the in-vehicle RF receiver 3 has failed in the despread (6350).

In this case, the in-vehicle LF transmitter 1 receives the notification from the in-vehicle RF receiver 3 (S450) and transmits the synchronization signal to the in-vehicle RF receiver 3 (S455) and transmits LF data (request for re-command) including the synchronization signal and frequency change information to the portable device 2 (S460). The frequency change information transmitted by the process of S460 is for notifying the in-vehicle RF receiver 3 that the frequency F2 different from the previously used frequency F1 is to be used.

As a result of the performance of these processes, the in-vehicle RF receiver 3 receives the synchronization signal transmitted by the process of S455 (S655). Further, when the portable device 2 exists within a communication area near the vehicle, the portable device 2 receives the synchronization signal and the frequency change information transmitted by the process of S460 (S555).

Subsequently, the portable device 2 adjusts synchronization based on the synchronization signal (S560). Specifically, the period of the spread code outputted to the XOR operation circuit 25 from the CPU 24 is adjusted so as to coincide with the period indicated by the synchronization signal.

Then, the portable device 2 performs RF data output and DSSS process (S565) and transmits RF data (command) subjected to the spread process (S570). In this process of S570, the frequency F2 is used as the transmission frequency of the RF data, whereby interference caused when the frequency F1 is used can be avoided.

Also the in-vehicle RF receiver 3 having received the synchronization signal by the process of S655 adjusts synchronization based on the synchronization signal (S660). Specifically, the period of the spread code outputted to the XOR operation circuit 34 from the CPU 35 is adjusted so as to coincide with the period indicated by the synchronization signal.

Then, the in-vehicle RF receiver 3 receives the RF data (command) transmitted by the process of S570 (S665). Here, in this process of S665, the frequency F2 is used as a reception frequency.

When the in-vehicle RF receiver 3 receives the RF data by the process of S665, the in-vehicle RF receiver 3 performs the despread process (670). In this process of S670, the despread process is performed by the use of the spread code the period of which is adjusted by the process of S660, which is different from the process of S620.

That is, in the process of S620, synchronization is achieved in the mode using the sliding correlator or the matched filter. However, in the process of S670, the spread code the period of which is adjusted by the process of S660 is used.

For this reason, both of the spread process by the process of S565 and the despread process by the process of S670 are performed by the use of a spread code the period of which is adjusted based on the synchronization signal transmitted from the in-vehicle LF transmitter 1. For this reason, in the process of S670, even if synchronization is not achieved in the mode using the sliding correlator or the matched filter, synchronization can be achieved immediately based on the synchronization signal.

When the in-vehicle RF receiver 3 performs the despread process described above, the in-vehicle RF receiver 3 checks whether the in-vehicle RF receiver 3 succeeds in despread (S675). Here, when the in-vehicle RF receiver 3 succeeds in the despread (S675: success), like the process of S630, the in-vehicle RF receiver 3 performs the processes required to start the operations of various functions (S680).

On the other hand, when the in-vehicle RF receiver 3 fails in the despread in the process of S680 (S680: NO), the in-vehicle RF receiver 3 finishes the process without performing more process. That is, when the portable device 2 tries to conduct first RF transmission at the frequency F1 and fails in the first RF transmission, the portable device 2 tries to conduct second RF transmission at the frequency F2. Then, when the portable device 2 fails in the second RF transmission, the in-vehicle RF receiver 3 abandons the reception of information from the portable device 2 at that timing.

According to the electronic key system described above, when the portable device 2 conducts RF communication, the portable device 2 conducts the RF communication in the spread spectrum method. Thus, the electronic key system can improve resistance to noises. Further, when the portable device 2 fails in the first RF communication, the portable device 2 conducts the second and subsequent RF communications by changing communication frequencies. Thus, further in this point, the electronic key system can improve resistance to noises.

Further, according to the electronic key system described above, the synchronization signal is transmitted to the portable device 2 and the in-vehicle RF receiver 3 at the timing when the LF radio signal is transmitted to the portable device 2 from the in-vehicle LF transmitter 1. With this, synchronization can be achieved between the portable device 2 and the in-vehicle RF receiver 3.

Thus, when the portable device 2 and the in-vehicle RF receiver 3 conduct communication in the spread spectrum method, synchronization can be achieved quickly even without using the sliding correlator or the matched filter. Hence, the responsivity of the electronic key system can be improved.

In particular, in the case of the smart entry function, when the first RF communication is conducted, synchronization is already achieved between the portable device 2 and the in-vehicle RF receiver 3. Hence, the responsivity of the electronic key system becomes very excellent.

Moreover, in the case of the remote keyless entry function, only when the first RF communication is conducted, the synchronization is achieved in the mode using the sliding correlator or the matched filter. However, when the second and subsequent RF communications are conducted, synchronization can be quickly achieved even without using the sliding correlator or the matched filter. Thus, in the case of the first RF communication being not successfully conducted, when the second and subsequent RF communications are conducted, the responsivity of the electronic key system can be improved.

The embodiment of the present invention has been described above. The present invention is not limited to the above specific embodiment, but can be carried out in various modes other than this embodiment.

For example, an example of conducting communication in the DSSS (direct sequence spread spectrum) mode has been described as a specific example of the spread spectrum method. However, a FHSS (frequency hopping spread spectrum mode) can be also taken as another specific example of the spread spectrum method. Either of these systems may be employed. Further, the mode of using the DSSS mode and the FHSS mode in combination may be employed.

Further, in the above embodiment, when RF communication is conducted, a total of two communications are tried by the use of the frequencies F1, F2. However, the construction such that three and subsequent RF communications are tried at further changed frequencies and the construction such that RF communication is again tried at both or one of the frequencies F1, F2 may be employed.

Still further, in the above embodiment, the communication is conducted in the spread spectrum method and the communication is again tried when communication is not successfully conducted, in both cases of the smart key entry function and the remote key entry function. However, these can be employed in combinations.

That is, only in the case of the smart entry function being used, communication may be conducted in the spread spectrum method or communication may be again tried when communication is not successfully conducted. Alternatively, only in the case of the remote keyless entry function being used, communication may be conducted in the spread spectrum method or communication may be again tried when communication is not successfully conducted.

Still further, in the above embodiment, the mode of achieving synchronization based on the synchronization signal from the in-vehicle LF transmitter 1 or the mode of achieving synchronization by the use of the sliding correlator or the matched filter is used properly. That is, one of these modes is used according to circumstances to thereby achieve synchronization. However, these modes can be also used in combination.

Specifically, there may be employed the construction in which when synchronization is achieved based on the synchronization signal from the in-vehicle LF transmitter 1, the synchronization may be achieved in parallel by the use of the sliding correlator or the matched filter. If this construction is employed, when it is verified whether the synchronization is properly achieved based on the synchronization signal from the in-vehicle LF transmitter 1 or when synchronization is not properly achieved based on the synchronization signal from the in-vehicle LF transmitter 1, in place of synchronization being achieved based on the synchronization signal from the in-vehicle LF transmitter 1, synchronization can be achieved by the use of the sliding correlator or the matched filter.

Even when such a construction is employed, usually, synchronization can be achieved based on the synchronization signal from the in-vehicle LF transmitter 1, so that synchronization can be quickly achieved. Further, when an error occurs in the synchronization signal accidentally, it is possible to prevent synchronization from being achieved based on the erroneous synchronization signal or synchronization from being not achieved, so that synchronization can be achieved more surely.

It is to be noted that the electronic key system may be applied to various control objects such as offices, houses, other than vehicles.

What is claimed is:

1. An electronic key system comprising:
a portable device carried by a user; and
an in-vehicle device mounted on a vehicle for conducting radio communication with the portable device to make verification of the portable device, the verification being required to perform various controls on the vehicle,
wherein the in-vehicle device is configured to transmit a synchronization signal when transmitting a radio signal to the portable device,
wherein the portable device is configured to transmit a radio signal in a spread spectrum method when transmitting the radio signal to the in-vehicle device, and
wherein the portable device is configured to adjust a period of a spread code used therein based on the synchronization signal to thereby synchronize the period of a spread code with a period of a spread code used in the in-vehicle device.

2. The electronic key system as claimed in claim 1, wherein:
the in-vehicle device is configured to transmit a response request to the portable device along with the synchronization signal, receive a response from the portable device in response to the response request, and perform the verification; and
the portable device is configured to transmit the response in the spread spectrum method to the in-vehicle device, by adjusting the period of a spread code based on the synchronization signal to thereby synchronize the period of a spread code with the period of a spread code used in the in-vehicle device.

3. The electronic key system as claimed in claim 2, wherein:
the in-vehicle device is configured to transmit the response request again to the portable device along with the synchronization signal, if the in-vehicle device fails to receive the response normally from the portable device; and
the portable device is configured to transmit the response again to the in-vehicle device in the spread spectrum method by changing a transmission frequency so that the in-vehicle device performs the verification again, the portable device adjusting a period of a spread code used in the portable device based on the synchronization signal transmitted again from the in-vehicle device to thereby synchronize the period of a spread code used in the portable device with a period of a spread code used in the in-vehicle device.

4. The electronic key system as claimed in claim 1, wherein:
the portable device is configured to transmit a command to the in-vehicle device in the spread spectrum method so that the in-vehicle device receiving the command performs the verification; and
the in-vehicle device is configured to adjust a period of a spread code used in the in-vehicle device by the use of a sliding correlator or a matched filter to thereby synchronize a period of a spread code used in the in-vehicle device with a period of a spread code used in the portable device.

5. The electronic key system as claimed in claim 4, wherein:
the in-vehicle device is configured to transmit a command request to the portable device along with the synchronization signal, if the in-vehicle device fails to receive the command normally from the portable device; and
the portable device is configured to transmit the command again to the in-vehicle device in the spread spectrum method by changing a transmission frequency so that the in-vehicle device performs the verification again, the portable device adjusting a period of a spread code used in the portable device based on the synchronization signal transmitted again from the in-vehicle device to thereby synchronize the period of a spread code used in the portable device with a period of a spread code used in the in-vehicle device.

6. An electronic key method for performing radio communication between a portable device carried by a user and an in-vehicle device including a transmitter and a receiver mounted on a control object to make verification of the portable device, which is required to perform a predetermined control on the control object by the portable device, the electronic key method being characterized by:
transmitting, from the transmitter, a synchronization signal to the receiver and a radio signal to the portable device including a data of the synchronization signal;
transmitting, from the portable device, a radio signal to the receiver by performing a spread spectrum process in response to the radio signal received from the transmitter;
performing, by the receiver, a despread spectrum process to make the verification of the portable device in response to the radio signal received from the portable device,
wherein both the spread spectrum process and the despread spectrum process are performed by using spread codes, which are adjusted with respect to respective periods based on the synchronization signal.
